(19) United States
(12) Patent Application Publication
(10) Pub. No.: US 2013/0179221 A1
(43) Pub. Date: Jul. 11, 2013

(54) Live Polling Means

(71) Applicant: Kongchith Xamonthene, Everett, WA (US)

(72) Inventor: Kongchith Xamonthene, Everett, WA (US)

(21) Appl. No.: 13/345,734

(22) Filed: Jan. 8, 2012

(51) Int. Cl. G06Q 30/02

(52) U.S. Cl. 705/7.32

(57) ABSTRACT

A live polling means used to distribute a polling request on whether or not to purchase a product or for any polling purpose between a user and members of a user's social network, commonly via mobile phones or handheld computers. A user creates a product profile by completing product information fields manually or via prior art product code/barcode scanning means; alternatively and similarly, a user submits a polling purpose with information reasonably necessary for polling members to make a polling decision, for example, a proposed meeting time. Poll members respond with a final decision whether or not to buy, or alternatively with a ‘yes’ or ‘no’ final decision, and may submit comments along with a final decision. User-created personal profiles, product profiles, polling purposes, final decisions and comments are sent to a third party for creating and maintaining product information and polling purpose database(s).

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to electronic commerce applications using digital and analog networks for personal computer and telephone use. More specifically, the present invention relates to live polling of online communities. More specifically, the present invention relates to the sale of and/or the exchange of information regarding consumer buying preferences and habits.

2. Description of Related Art

Currently social networks such as Facebook and Twitter permit live exchanges between users on topics of interest. Long standing consumer periodicals such as Consumer Reports collect product information from thousands of submissions by actual consumers.

What does not exist is an application for live polling within a social community where a social network can be instantly polled for any purpose including whether to buy a product.

### SUMMARY OF THE INVENTION

Therefore, it is first feature of the present invention to permit live polling request(s) for any polling purpose including decisions whether to buy or not buy a consumer product; said polling is enabled by creation of a social network to submit and/or to respond to polling request(s) by a single software means user as accessed by a mobile phone, tablet computer and/or personal computer (herein ‘computer means’) and may additionally utilize a website means whereby said social network is comprised of website account holders.

It is a second feature of the present invention to comprise a means for entering product information thereby forming a product profile as an ancillary process to the first feature above and as an ancillary process to the third feature below; said second feature further applies to the alternative embodiment whereby any polling purpose is entered as the subject of a poll.

It is a third feature of the present invention to accumulate, store, and organize transactional data such as polling purposes, product information, user profiles, social network member polling habits and choices, and social network polling information whereby the above forms of information may be valuable and monetizable assets generated from use of the present invention.

It is a fourth feature of the present invention to provide a list or menu of common responses to a product polling request that may include useful and/or demonstrative responses offered by the website means, and/or a stored list of responses that a user has already created. This feature promotes live polling where a responder is able to participate quickly and easily by simply selecting a website-generated list of responses and/or a list of the user's previous responses. Any response offered in the fourth feature is in addition to a poll responder's “buy” or “do not buy” final polling feedback.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

Therefore it is a purpose of the present invention to enable live polling for consumer product buying decisions.

Therefore it is a purpose of the present invention to create a social network for a user such that said network or subgroup of said network may provide trusted feedback on a potential purchase and in the converse for the user to provide said feedback.

Therefore it is a purpose of the present invention to collect information on consumer buying choices and habits

The characteristics and utilities of the present invention described in this summary and the detailed description below are not all inclusive. Many additional features and advantages will be apparent to one of ordinary skill in the art given the following detailed description.

### BRIEF DESCRIPTION OF THE DRAWINGS

FIG. 1 is a flowchart diagram showing how the present invention is used to generate product data, live product polling requests, product polling responses, and data gathering.

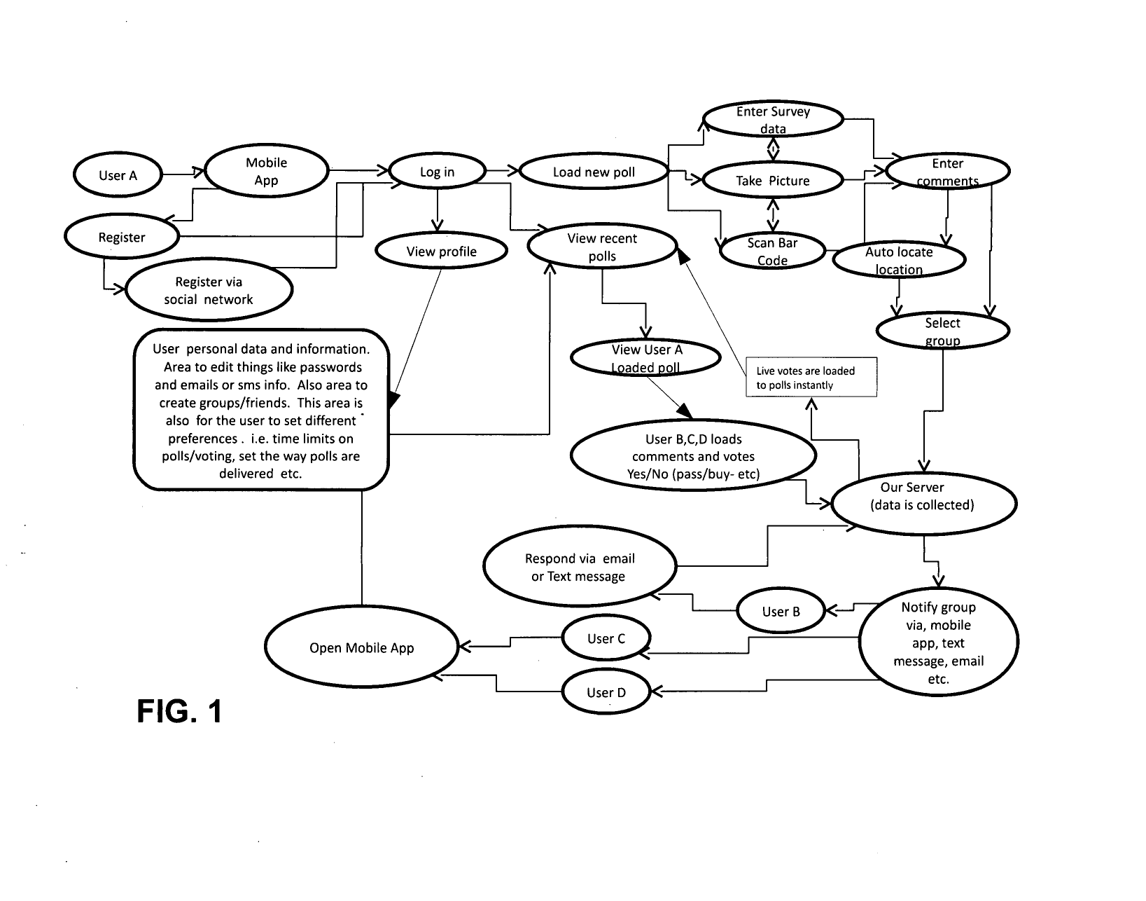

### DETAILED DESCRIPTION

In use, a user creates a profile and a social network on a computer means using a software means alone or alternatively in electronic communication with a website means whereby a website Controller permits account creation and administration. Profile and/or account information may be downloaded from already existing accounts on separate social networks for ease of registration. A software means is downloaded onto a user's mobile phone and/or personal computer whereby said software can be downloaded as a mobile phone application and/or a personal computer application. A user's friends within the social network on the website are also account holders and may control activity through their account settings, however, the present invention is not limited to sending a poll request to just those who are account holders on the website. A user's friends may receive only the portion of the software means permitting them to participate in a polling request upon receiving said request from a user; to participate initially, said friend is required to download the portion of the software means that enables viewing of product profile information and communication means comprising: responding to the polling request including but not limited to comments and final polling decision submission and a notification means to indicate to a user that a polling response was submitted.

In operation, a user creates a product profile of an item he is interested in by photographing said item and/or entering product information including but not limited to place of purchase, brand, size, quality, and/or other factors relevant to a buying decision. Additionally anticipated is incorporation of bar code scanning prior art and electronic communication with and/or storage of product data identified with said bar code on memory storage device(s) via the present invention website means and may be communicated to those who receive and request a polling request. A user then chooses whom to send a polling request (polling member(s)). Polling member(s) receive a notification of said request via email or text and if choose to participate in the polling then open the present invention mobile phone application or their website account to view pending polling requests.

A feature of the present invention is the combination of the polling member final polling decision to buy or not buy with comments that accompany said final polling decision. The present invention further comprises the data recording, organizing and collection regarding any linguistic relationship or other relationship created between a final polling decision (buy or not buy) with said accompanying comments. Said comments may be offered as: a list of prepared comments offered by the website means upon presenting a polling request to a polling member; a set of the polling member's past comments; or a combination thereof.

A user is delivered by text and/or email and/or to the website account the results of polling requests that were responded to and may receive said results in various statistical presentations or other means for expressing final polling decision results, a linguistic expression of the comments provided with the final polling decisions, or a combination thereof. By way of example, the software means may record the number of times polling responders used the phrase “I like it” or “It's ok” and statistically weigh said responses against a final polling decision whereby some users who may comment “I like it” or “It's ok” may recommend purchasing while other users providing the same comments do not recommend purchasing. Said linguistic expression and/or said combination with the polling member's final polling decision is herein referred to as a polling member's ‘buying habit expression’ and further comprises the present invention.

A notification means comprises an audio and/or visual alert indicating receipt of a polling request or a polling response.

A memory storage means and the software means is further employed for the purpose of collecting, organizing, and recording product profiles with final polling decisions and/or buying habit expressions associated with said profile. The utility of said information is the creation of marketing information for those products polled and the related creation of a database of buying habit expression data.

In an alternative embodiment, the present invention described above is used for any polling purpose whereby polling members are polled for any purpose including but not limited to meeting time availability, event planning, and informal surveys. A user enters a polling purpose into a polling purpose field which comprises a polling request that can be answered definitively in the affirmative or negative as comprising the final polling decision, for example, a proposed meeting or event time whereby polling members respond with at least the affirmative or negative response (for example, “thumbs up” or “thumbs down”) and may additionally include comments.

The previous is a detailed description of embodiments of the present invention. As these embodiments of the present invention are described, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, the description is not to be considered in a limiting sense, as it is understood that the present invention is in no way limited to the embodiments described.

What is claimed is:

1. A live polling means comprising:
1) A software means used with a computer device including but not limited to a mobile phone, tablet personal computer, and/or personal computer to create a user profile, create a product profile or a polling purpose, and communicate with poll members to achieve a purpose(s) of the present invention; a website means as operated by a Controller that permits user account creation and the transfer of information between members including but not limited to product profile information, poll member comments, and/or poll member final polling decisions; whereby said software means may operate as an independent live polling means or in the alternative may operate together with said website means to achieve the purposes of the present invention.
2) The software means and product profile or polling purpose of claim 1 whereby:
said software means includes a means for transferring a digital image as part of a product profile or polling purpose to a polling member;
said digital image may include a product code, bar code and/or Uniform Product Code symbol;
prior art product code, barcode and/or Uniform Product Code reading means may be employed to populate product information fields where said prior art means is in electronic communication with a memory storage device where product information is stored and where said prior art means is capable of transferring the digital image of a product code, bar code and/or Uniform Product Code into an electronically readable medium; and
said product profile or polling purpose further comprises a request to provide information about a product or polling purpose reasonably necessary for a polling member to make a polling decision.
3) The software means of claim 1 further comprising a means for collecting and statistically arranging and presenting the final polling decision and/or comments of polling members whereby:
a memory storage device is employed by the computer device of claim 1 to store said collected final polling decisions and comments of polling members, a history of previously made said final polling decisions and comments of polling members, product profiles, a user's profile information and/or a polling member's profile information;
said software means further comprises a notification means to notify a polling member of a polling request or a user of a polling response via text messaging, email, and/or electronic communication means transmitted and received between users of said software means such that polling requests and polling responses are formatted via said software means for the specific type of polling purpose and whereby said notification means further comprises an audio and/or visual alert of a received polling response;
said software means is employed to send said final polling decisions and comments to said memory storage device; and
said software means is employed to electronically communicate said final polling decisions and comments, the associated product profile, the user profile and any polling member profiles to a third party from said memory storage device and/or temporary memory means and/or via a third party receiving means whereby electronic communication occurs concurrently or otherwise between a user/polling member and said third party receiving means upon use of said software means to enter said final polling decisions and comments into and/or upon electronically sending said final polling decisions and comments to another via said software means.
